(19) United States
(12) Patent Application Publication
(10) Pub. No.: US 2007/0091391 A1
(43) Pub. Date: Apr. 26, 2007

(54) Image forming device

(76) Inventor: Yasushi Saito, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,081

(22) Filed: Oct. 26, 2005

(51) Int. Cl. H04N 1/46

(52) U.S. Cl. 358/530

(57) ABSTRACT

An image forming device comprises a document image capturing unit 11 for reading a document and capturing a document image; an advertisement image memory unit 32 for storing advertisement images to be printed in addition to the document image; a first color setting unit 22 for a user to set a color specified by the user as the color for the main image; a second color setting unit 24 for coloring an advertisement image with a color different from the first color setting unit 22; a composing unit 27 for composing an advertisement image in the marginal regions of a document image; and a printing unit 15 for printing the image composed by the composing unit 27 on recording paper.

### FIELD OF THE INVENTION

The present invention relates to an image forming device for color printing document images on recording paper.

### BACKGROUND INFORMATION

In recent years, at convenience stores and the like, advances have been ongoing in copying services with advertisements, wherein predetermined advertisement images (additional images) are added to and printed on recording paper and the copying fees are discounted. Technology exists for services with advertisements. These technologies disclose a digital output device for printing advertisement images in the margin portions of the recording paper, on the back side of the recording paper, or the like, and discounting the user's copying fees based on the amount of toner consumed during printing, the size of the advertisement image, and the like.

However, these technologies include no descriptions relating to color printing, and imply monochrome printing. An object of the present invention is to provide an image forming device which can improve the visibility of advertisement images in color printing and improve the advertising effects of the advertisement images.

### SUMMARY OF THE INVENTION

The image forming device relating to the present invention is an image forming device for color printing a document image on recording paper, comprising image capturing means for capturing a document image; memory means for storing advertisement images to be printed in addition to the document image; color setting means for setting a color different from the color of the main image, which is the image in the document image excluding the ground portion, as the color of the advertisement images; composing means for composing the document image and the advertisement image with the color set with the color setting means; and printing means for printing on recording paper an image composed by the composing means.

In this constitution, the color setting means preferably comprise: first color setting means for receiving an operation command from a user for specifying the color for the main image, and setting the color specified by the operation command as the color of the main image; and second color setting means for setting a color different from the first color setting means as the color of the advertisement image.

This constitution preferably further comprises color presenting means for presenting the colors to the user, different from the color set with the first color setting means, from among a plurality of predetermined colors; and the second color setting means preferably receive an operation command from the user for specifying the color of the advertisement image, from among the colors shown by the color presenting means, and set the color specified by the operation command as the color of the advertisement image.

In this constitution, the color presenting means preferably comprises display means for preview display of the advertisement image colored with the shown color.

With the invention in claim 1, an advertisement image colored differently from the color of the main image, excluding the ground portion of the document image, is composed with the document image and printed on recording paper; therefore, the difference between the advertisement image and the main image becomes marked, the visibility of the advertisement image is improved, and as a result, the advertising effects of the advertisement image can be improved.

With the invention in claim 2, when the user specifies a color for the main image, a color different from the specified color is set as the color for the advertisement image; and therefore, the advertising effects of the advertisement image can be improved, even for image forming devices which employ such a printing mode.

With the invention in claim 3, the user's preference is acquired when setting the colors for the main image and advertisement image, the difference between the images can be made marked, and the advertising effects can be improved.

With the invention in claim 4, the advertisement image colored with candidate coloring is displayed as a preview; therefore, the user easily selects the color for the advertisement image.

### BRIEF DESCRIPTION OF THE DRAWINGS

FIG. 1 is a schematic side view principally showing the mechanical constitution of the image forming device according to the present invention applied to a copier.

FIG. 2 is a block diagram showing the functional constitution of the copier shown in FIG. 1.

FIG. 3 is a flowchart showing the operation of the copier.

FIG. 4 is a drawing showing an example of the operation image displayed on the display unit when the user sets the color for the main image.

FIG. 5 is a drawing showing an example of the operation image displayed on the display unit when the user sets the color for the advertisement image.

FIG. 6 is a drawing showing an example of a color contrast table.

### DETAILED DESCRIPTION OF THE PREFERRED EMBODIMENTS

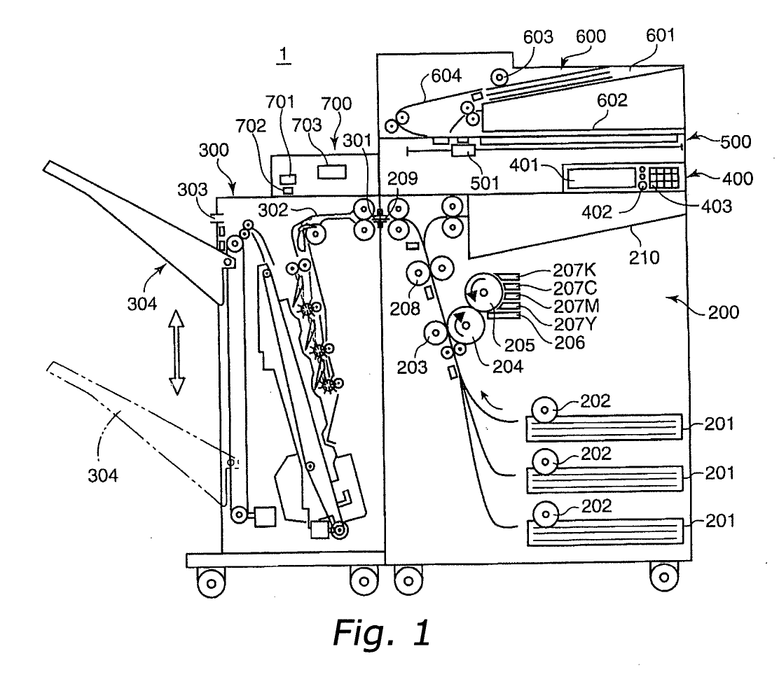

Embodiments of the present invention are described below with reference to the drawings. FIG. 1 is a side schematic view principally showing the mechanical constitution of the image forming device according to the present invention applied to a copier. This copier is installed in a shop providing copying service to users, such as a convenience store, stationery goods shop, or the like. This copier comprises a main unit 200, a paper after-processing unit 300 provided on the left side of the main unit 200, an operation unit 400 for the user to input various operation commands and the like, a document reading unit 500 provided on the upper portion of the main unit 200, a document feeding unit 600 provided above the document reading unit 500, and a fee collecting device 700 for the user to pay copying fees.

The operation unit 400 comprises an operation panel 401, a start key 402, a numeric key pad 403, and the like. The operation panel 401 displays various operation screens, along with various operation buttons for the user to input various operation commands. The start key 402 is used for the user to input the print command and the like; the numeric key pad 403 is used for inputting the number of copies and the like.

The document feeding unit 600 comprises a document loading unit 601, document output unit 602, feed roller 603, document transport unit 604, and the like; and the document reading unit 500 comprises a. scanner 501 and the like. The feed roller 603 feeds the document set on the document loading unit 601; and the document transport unit 604 transports the fed document over the scanner 501, one page at a time. The scanner 501 successively reads transported documents and the read documents are output to the document output unit 602.

The main unit 200 comprises a plurality of paper cassettes 201, a plurality of feed rollers 202, a transfer roller 203, an intermediate transfer roller 204, a photosensitive drum 205, an exposure device 206, development devices 207Y, 207M, 207C, 207K for each of the colors yellow, magenta, cyan, and black, a fixing roller 208, an outlet 209, an output tray 210, and the like.

The photosensitive drum 205 is charged uniformly by a charging device (not shown) while rotating in the direction shown by the arrow. The exposure device 206 converts a modulated signal generated based on the document image data read by the document reading unit 500 to a laser beam and outputs the laser beam, so as to form an electrostatic latent image for each color on the photosensitive drum 205. The development devices 207Y, 207M, 207C, 207K supply developer in each color to the photosensitive drum 205 and form toner images in each color.

The toner image in each color is transferred from the photosensitive drum 205 to the intermediate transfer roller 204 and a color toner image is formed on the intermediate transfer roller 204.

Meanwhile, the feed roller 202 withdraws recording paper from a paper cassette 201, which contains recording paper, and feeds the paper to the transfer roller 203. The transfer roller 203 transfers the toner image on the intermediate transfer roller 204 to the transported recording paper; and the fixing roller 208 heats the transferred toner image so as to fix the toner image to the recording paper. Thereafter, the recording paper is transported to the paper after-processing unit 300 from the outlet 209 of the main unit 200. The recording paper is output to the output tray 201 as necessary.

The paper after-processing unit 300 comprises an infeed opening 301, a recording paper transport unit 302, an outlet 303, a stacking tray 304, and the like. The recording paper transport unit successively 302 transports the recording paper transported from the outlet 209 to the infeed opening 301, and finally outputs the recording paper from the outlet 303 to the stacking tray 304. The stacking tray 304 is constituted so as to be able to move vertically in the direction shown by the arrow according to the cumulative number of sheets of recording paper output from the outlet 303.

The fee collecting device 700 comprises a bill slot 701 for the user to insert bills, a coin slot 702 for the user to insert coins, a display unit 703 to display the total amount of the inserted bills and coins, and the like.

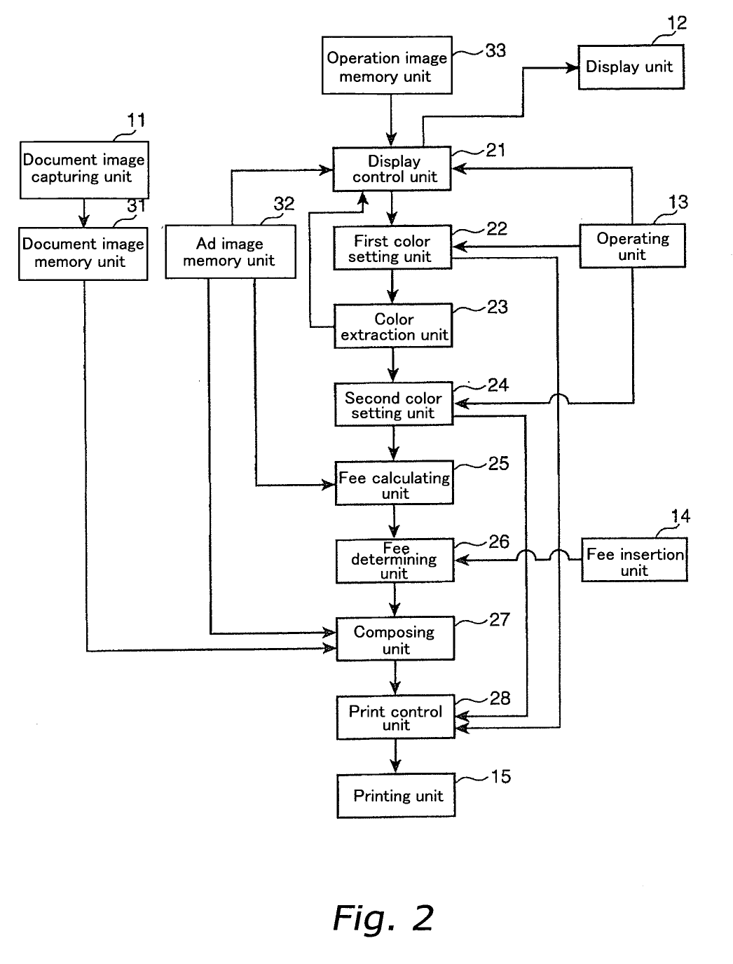

FIG. 2 is a block diagram showing the functional constitution of the copier shown in FIG. 1. This copier comprises a document image capturing unit 11, a display unit 12, an operation unit 13, a fee inserting unit 14, a printing unit 15, a display control unit 21, a first color setting unit 22, a color extraction unit 23, a second color setting unit 24, a fee calculating unit 25, a fee determining unit 26, a composing unit 27, a print control unit 28, a document image memory unit 31, an advertisement image memory unit 32, and an operation image memory unit 33.

The display control unit 21 through the printing control unit 28 comprise CPUs and the like; the document image memory unit 31 through the operation image memory unit 33 comprise memory devices such as hard disk drives, RAM, or the like.

The document image capturing unit 11 comprises the image reading unit 500 shown in FIG. 1, and captures the image of the document (hereinafter “document image”) by optically reading the document and storing the image to the document image memory unit 31. In this specification, the image outside of the image showing the ground portion of the recording paper included in the document image is called the main image. The display unit 12 comprises the operation panel 401 shown in FIG. 1, and displays various images under the control of the display control unit 21.

The operation unit 13 comprises the operation unit 400 shown in FIG. 1 and receives various operation commands input by the user. In this embodiment, the operation unit 13 receives, in particular, operation commands for specifying the color of the main image, operation commands for specifying the color of the advertisement image, and the like.

The fee insertion unit 14 comprises the fee collecting device 700 shown in FIG. 1, and distinguishes the types of bills and coins inserted by the user and calculates the total amount of bills and coins paid by the user. The printing unit 15 comprises the transfer roller 203, intermediate transfer roller 204, photosensitive drum 205, exposure device 206, development devices 207Y, 207M, 207C, 207K, and the fixing roller 208 shown in FIG. 1, and prints the output image generated by the print control unit 28 on recording paper.

The document image memory unit 31 stores the document image captured by the document image capturing unit 11. The advertisement image memory unit 32 stores the advertisement images and the predetermined discount rates for the advertisement images. The operation image memory unit 33 stores the various operation images displayed on the display unit 12 when the user inputs various operation commands for the copier.

The display control unit 21 causes the display unit 12 to display various operation images stored in the operation image memory unit 33. The display control unit 21 causes the display unit 12 to display various data input by the user via the operation unit 13. Furthermore, the display control unit 21 generates thumbnail images of the advertisement images stored in the advertisement image memory unit 32, colors the generated thumbnail images with each candidate color extracted by the color extraction unit 23, generates a preview image for each candidate color, and causes the display unit 12 to display the preview images.

The first color setting unit 22 sets, as the color for the main image, the color specified by the user via the operation unit 13 as the color for the main image. This copier can perform monochrome color printing using black, yellow, cyan, magenta, red, green, and blue; the user specifies one of these colors as the color for the main image.

The color extraction unit 23 extracts as candidate colors for the advertisement image colors other than light colors which are difficult for the user to see, and which are different from the color set with the first color setting unit 22, from among the abovementioned colors used for monochrome color printing. In this copier, the candidate colors are extracted from colors, excluding yellow which is a light color, from among black, yellow, cyan, magenta, red, green, and blue.

The second color setting unit 24 sets, as the color for the advertisement image, the color specified by the user via the operation unit 13, from among the candidate colors extracted by the color extraction unit 23.

The fee calculating unit 25 calculates the copying fees by reading the discount rate for the advertisement image from the advertisement image memory unit 32 and multiplying the predetermined copying fee per page of recording paper by the read discount rate. The fee calculating unit 25 may also vary the discount rate for each color set by the second color setting unit 24. In this case, the discount rate for the copying fees for each color may be stored in the advertisement image memory unit 32.

The fee determining unit 26 determines whether the total amount of bills and coins paid by the user via the fee insertion unit 14 is greater than the copying fees calculated by the fee calculating unit 25; and, when greater, outputs a control signal to generate an output image to the print image control unit 27.

The composing unit 27 extracts as marginal regions those regions, where the ground portion is continuously larger than a fixed size, from the document image with the color set by the first color setting unit 22; adjusts the size of the advertisement image so that the entire advertisement image with the color set by the second color setting unit 24 is contained within the extracted marginal regions, and composes the document image and advertisement image. The print control unit 28 controls the printing unit 15 so that the image composed by the composing unit 27 is printed on the recording paper.

In this embodiment, the document image capturing unit 11 corresponds to an example of image capturing means; the advertisement image memory unit 32 corresponds to an example of memory means; the operation unit 13, first color setting means 22, color extraction unit 23, and second color setting means 24 correspond to an example of color setting means; the composing unit 27 corresponds to an example of composing means; the print control unit 28 and printing unit 15 correspond to an example of printing means; and the color extraction unit 23, display control unit 21, and display unit 12 correspond to an example of color presenting means.

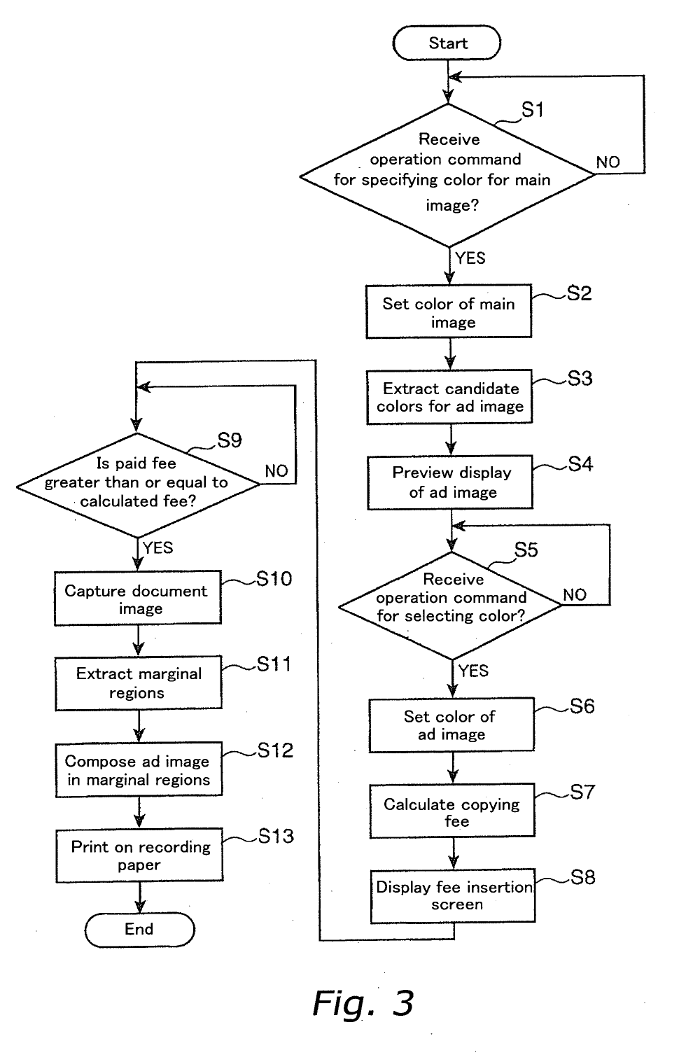

FIG. 3 is a flowchart showing the operation of this copier. The operation of this copier is described below, along with the flowchart in FIG. 3. In Step S1, when the operation unit 13 receives an operation command from the user for specifying the color of the main image (YES in S1), the first color setting unit 22 sets the specified color as the color of the main image (S2). Meanwhile, in Step S1, when the operation unit 13 does not receive the operation command (NO in S1), the process returns to Step S1.

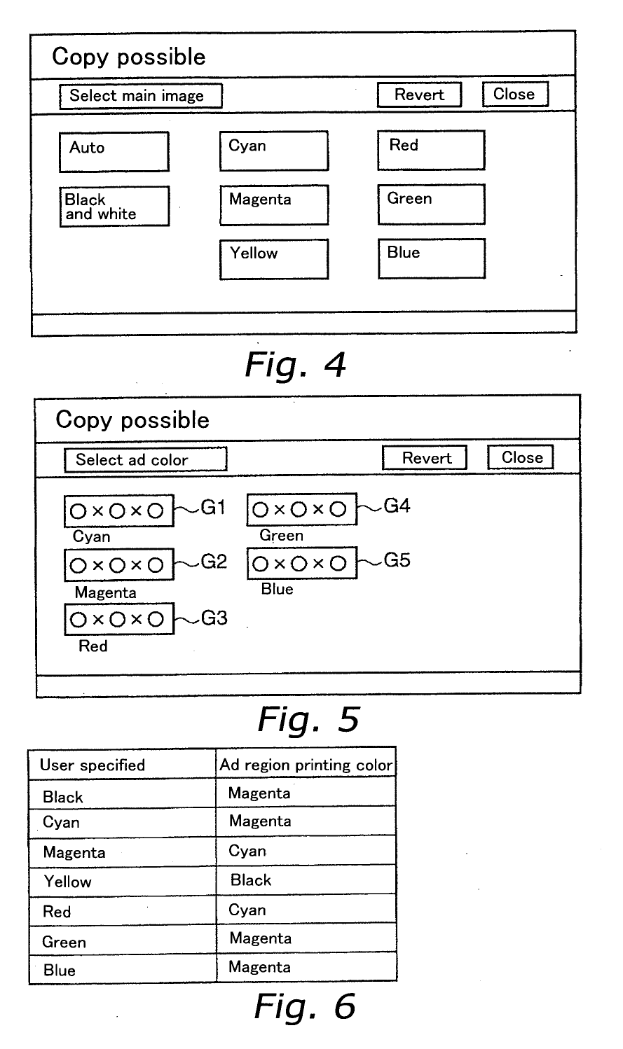

FIG. 4 is a drawing showing an example of the operation image displayed on the display unit 12 by the display control unit 21 in Step S1. As shown in FIG. 4, this operation image includes a display of buttons labeled “Auto”, “Black and white”, “Cyan”, “Magenta”, “Yellow”, “Red”, “Green”, and “Blue” below the title “Main image selection”.

When the “Auto” button is pressed, this copier prints the color of the document read by the document image capturing unit 11 without further processing on recording paper. In this case, this copier prints the document image on recording paper in full color. Also, when the “Black and white”, “Cyan”, “Magenta”, “Yellow”, “Red”, “Green”, and “Blue” buttons are pressed, this copier performs monochrome color printing of the main image in black, cyan, magenta, yellow, red, green, or blue, respectively.

In Step S3, the color extraction unit 23 extracts, as candidate colors for the advertisement image, colors other than the color specified by the user for this image, excluding those light colors which are difficult for the user to see, from among black, cyan, magenta, yellow, red, green, and blue. Specifically, colors other than the color set for the main image are extracted as candidate colors from among black, cyan, magenta, red, green, and blue, but not yellow. The color extraction unit may also exclude colors other than yellow as candidate colors.

In Step S4, the display control unit 21 colors the thumbnail image of the advertisement image with each candidate color extracted by the color extraction unit 23, generates a preview image for each candidate color, and causes the display unit 12 to display a list of the generated preview images. FIG. 5 is a drawing showing an example of an image displayed on the display unit 12 in Step S4. As shown in FIG. 5, the five preview images G1 through G5 are displayed below the column title “Advertisement color selection”. In the example in FIG. 5, preview images G1 through G5 in the colors cyan, magenta, red, green, and blue, but not black, are displayed because the user specified black as the color of the main image in Step S3.

In Step S5, when the operation unit 13 receives an operation command for the user to specify a color for the advertisement image (YES in S5), the second color setting unit 24 sets the color indicated by the operation command received by the operation unit 13 as the color for the advertisement image (S6). In Step S5, when the operation unit 13 does not receive an operation command for the user to specify a color for the advertisement image (NO in S5), the process returns to Step S5. On the screen shown in FIG. 5, the user specifies the color for the advertisement image by touching any of the preview images G1 through G5 displayed on the display unit 12.

In Step S7, the fee calculating unit 25 calculates the copying fee by multiplying the copying fee per one sheet of recording paper by the predetermined discount rate for the advertisement image stored in the advertisement image memory unit 32. When a different discount rate is determined in advance for each color, the fee calculating unit 25 calculates the copying fee by reading from the advertisement image memory unit 32 the discount rate for the color of the advertisement image specified by the user, and multiplying the read discount rate by the copying fee per page of recording paper.

In Step S8, the display control unit 21 causes the display unit 12 to display an image to inform the user of the calculated copying fee. In Step S9, the fee calculating unit 25 compares the total amount of bills and coins inserted by the user via the fee insertion unit 14 with the copying fee calculated by the fee calculating unit 25; when the total amount is greater than or equal to the calculated copying fee (YES in S9), the process advances to Step S10; when the total amount is less than the calculated copying fee (NO in S9), the process returns to Step S9.

In Step S10, the document image capturing unit 11 reads the document placed in the document loading unit 601 and stores the image to the document image memory unit 31. In Step S11, the composing unit 27 extracts the marginal regions from the document image, composes the advertisement image in the extracted marginal regions (S12), and generates an output image. In this way, the advertisement image is composed in the marginal regions of the document image; therefore, the overlapped printing of the document image and advertisement image is avoided and the visibility of both images can be improved.

In Step S13, the print control unit 28 controls the printing unit 15 so that, in the output image generated by the composing unit 27, the main image is printed with the color set with the first color setting unit 22 and the advertisement image is printed with the color set with the second color setting unit 24 on the recording paper.

With this copier as described above, because the user specifies the color for the main image and then a different color from that specified is set as the color for the advertisement image, the difference between the advertisement image and the main image becomes marked, the visibility of the advertisement image is improved, and as a result the advertising effects of the advertisement image can be improved.

The present invention may also be employed in the following modes.

(1) The previous embodiment employed a mode wherein the user was caused to select the color for the advertisement image, but the invention is not limited to this, and a mode may be employed wherein the copier automatically sets the color for the advertisement image.

Specifically, a color contrast table as shown in FIG. 6 is stored in the advertisement image memory unit 32; the second color setting unit 24 may reference this color contrast table and set the color for the advertisement image. The color contrast table shown in FIG. 6 comprises a “User specified” column showing the colors specified by the user for the main image and an “Advertisement image printing color” column, of colors extracted by the color extraction unit 23 as colors for the advertisement image corresponding to the user-specified colors. According to this color contrast table, when black, cyan, magenta, yellow, red, green, or blue is set for the main image, the second color setting unit 24 sets magenta, magenta, cyan, black, cyan, magenta, or magenta respectively as the color for the advertisement image.

Accordingly, when the user sets a desired color for the main image, a color which is different from the set color and with which the advertisement image will not lack visibility is automatically set as the color for the advertisement image; therefore, the work load on the user can be lightened, while the advertising effects of the advertisement image can be improved.

For automatically setting the color of the advertisement image, the copier may set, as the color for the advertisement image, a color which is different from the color of the recording paper and also a color which tends to have a greatly different hue (such as a complementary color) from the color set for the main image.

(2) In the foregoing embodiment, the case of printing a main image in a single color was described, but the invention is not limited to this and may be applied to the case of full color printing of the main image as well. In this case, the invention is further provided a color detecting unit for detecting the colors constituting the main image, and setting, as the color for the advertisement image, a color which is different from the colors detected by the color detecting unit. Specifically, the color detecting unit may set, as the color for the advertisement image, a toner color, from among yellow, cyan, magenta, and black toner, which is predicted to require the least toner consumption. Also, the color detecting unit may prepare a color histogram showing the color frequencies for a plurality of predetermined colors based on the C, M, Y, and K color components constituting the pixel data for the main image, and color the advertisement image with the color having the lowest occurrence (including zero).

What is claimed is:

1. An image forming device for color printing a document image on recording paper, comprising:
image capturing means for capturing a document image;
memory means for storing advertisement images to be printed in addition to the document image;
color setting means for setting a color different from the color of the main image, which is the image in the document image excluding the ground portion, as the color of the advertisement image;
composing means for composing the document image and advertisement image with the color set with the color setting means; and
printing means for printing on recording paper an image composed by the composing means.

2. The image forming device recited in claim 1, wherein the color setting means comprises:
first color setting means for receiving an operation command from a user for specifying the color for the main image, and setting the color specified by the operation command as the color of the main image; and
second color setting means for setting a color different from the first color setting means as the color of the advertisement image.

3. The image forming device, recited in claim 2, wherein the image forming device further comprises color presenting means for presenting to the user colors different from the color set with the first color setting means, from among a plurality of predetermined colors; and
the second color setting means receive an operation command from the user for specifying the color of the advertisement image, from among the colors shown by the color presenting means, and setting the color specified by the operation command as the color of the advertisement image.

4. The image forming device, recited in claim 3, wherein the color presenting means comprises display means for preview display of the advertisement image colored with the shown color.
